(19) United States
(12) Patent Application Publication
(10) Pub. No.: US 2026/0094360 A1
(43) Pub. Date: Apr. 2, 2026

(54) CONTENT-BASED PASSTHROUGH IMAGE PROCESSING

(71) Applicant: Apple Inc., Cupertino, CA (US)

(72) Inventors: Seyedkoosha Mirhosseini, Santa Clara, CA (US); Christian I Moore, Sunnyvale, CA (US); Christophe Seyve, Comberton (GB); Colin D Munro, San Jose, CA (US); Daniel A Glynn, Seattle, WA (US); Hengzhou Ding, Cupertino, CA (US); Luke A Pillans, Sunnyvale, CA (US); Renbo Cao, San Jose, CA (US); Simon Fortin-Deschenes, Santa Clara, CA (US); Yonghui Zhao, San Jose, CA (US)

(21) Appl. No.: 19/334,191

(22) Filed: Sep. 19, 2025

Related U.S. Application Data
(60) Provisional application No. 63/699,926, filed on Sep. 27, 2024.

(51) Int. Cl. G06T 15/20; H04N 23/611; H04N 23/88

(52) U.S. Cl. CPC G06T 15/205; H04N 23/611; H04N 23/88

(57) ABSTRACT

Various implementations disclosed herein include devices, systems, and methods that adjust camera parameters (e.g., exposure and/or white balance parameters) used for passthrough video based on contextual analysis. This may involve generating information that triggers an image signal processor (ISP) adjustment and/or information that is provided to an ISP to determine such parameter adjustments. The contextual analysis may account for the environment (e.g., the physical environment that is depicted in the view, virtual content added to provide a view of an XR environment, etc.), what the user is doing, where the user us gazing/focused, whether the user is moving, sitting, standing, etc., and other contextual factors.

### CROSS-REFERENCE TO RELATED APPLICATIONS

This Application claims the benefit of U.S. Provisional Application Ser. No. 63/699,926 filed Sep. 27, 2024, which is incorporated herein in its entirety.

### TECHNICAL FIELD

The present disclosure generally relates to systems, methods, and devices that adjust camera parameters for cameras used to provide passthrough video content on devices such as head-mounted devices (HMDs).

### BACKGROUND

Existing devices that provide views that include passthrough video may not adequately account for contextual factors to efficiently and effectively capture video and/or provide desirable user experiences.

### SUMMARY

Various implementations disclosed herein include devices, systems, and methods that adjust camera parameters (e.g., exposure and/or white balance parameters) used for passthrough video based on contextual analysis. This may involve generating information that triggers an image signal processor (ISP) adjustment and/or information that is provided to an ISP to determine such parameter adjustments. The contextual analysis may account for the environment (e.g., the physical environment that is depicted in the view, virtual content added to provide a view of an XR environment, etc.), what the user is doing, where the user us gazing/focused, whether the user is moving, sitting, standing, etc., and other contextual factors.

The contextual analysis may provide information that may be based on prioritizing one or more portions of the XR environment for parameter adjustment purposes. For example, a white balance adjustment may be based on information that identifies portions of a passthrough image of a physical environment (e.g., a spatial map/mask identifying a portion of a view, etc.) that can be ignored in determining the adjustments for subsequent passthrough image capture, e.g., providing information to use some portions of the image but to not use other portions of the image corresponding to other display devices, windows, etc. in determining the camera adjustments. In another example, a white balance adjustment may be based on information that identifies that a user is focused on/looking at their hands and thus that a skin display priority should be used in adjusting the camera parameters. As another example, a white balance adjustment may be based on information that identifies that an interaction event with another person (e.g., in the case of breakthrough display of the other person) and that a person display priority should be used in adjusting camera parameters. As another example, an exposure adjustment may be based on information that identifies that a user's focus is on a particular area within an indoor setting and thus that certain portions of the XR environment (e.g., the ceiling, the bright sun visible through a window, etc.) can be ignored in determining the adjustment. In another example, an exposure adjustment may be based on information that identifies that virtual content is blocking one or more elements of the XR environment in the user's current view and thus that those elements of the passthrough image environment that are behind the virtual content maybe ignored in determining the adjustment.

The information that triggers an ISP adjustment and/or that is provided to an ISP to determine its parameter adjustments may be based on identifying a user activity. For example, a white balance adjustment and/or exposure adjustment may be determined based on information that identifies a user head movement and/or a gaze behavior to be accounted for in determining the camera adjustment, e.g., slowing down camera adjustment updates in the case of fast user head and/or eye movements to avoid undesirable updating and/or promote stability within the passthrough views.

In some implementations, an electronic device has a processor (e.g., one or more processors) that executes instructions stored in a non-transitory computer-readable medium to perform a method. The method performs one or more steps or processes. In some implementations, the method is performed at an HMD having a processor, a display, and an outward-facing camera (e.g., one or more cameras) configured for tuning via an ISP (e.g., one or more ISPs). The method involves determining a context of a user viewing views of an XR environment on the display, the views comprising images of a physical environment captured via the outward-facing camera. The method involves generating information to provide to the ISP based on the context, wherein an exposure parameter or a white balance parameter of the camera is adjusted via the ISP based on the information. The information may be based on prioritizing one or more portions of the XR environment for parameter adjustment, e.g., masking out portions of images that depict other displays, windows, etc., identifying a focus on the user's hands based on user gaze, identifying an interaction with another person based on gaze and/or a change in the XR environment, identifying virtual content occluding other elements, etc. The information may be based on an identified user activity (e.g., where user is looking, head speed, etc.). The method involves capturing one or more additional images of the physical environment via the camera based on the adjusted exposure parameter or the adjusted white balance parameter of the camera and presenting one or more additional views of the XR environment comprising the additional images.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIGS. 2A-B illustrate an exemplary view of passthrough video of a physical environment and an example of virtual content to be added to such a view to provide a view of an XR environment, in accordance with some implementations.

FIG. 3 illustrates a view of an XR environment including passthrough video of a physical environment and virtual content, in accordance with some implementations.

FIG. 4 illustrates a chart of exemplary ways in which various inputs may be used to facilitate white balance adjustments, in accordance with some implementations.

FIG. 5 illustrates a chart of exemplary ways in which various inputs may be used to facilitate exposure adjustments, in accordance with some implementations.

FIGS. 6A-6B illustrate exemplary masks identifying portion of passthrough images to exclude in determining camera adjustments, in accordance with some implementations.

FIG. 7 illustrates accounting for user gaze or focus in determining a camera adjustment, in accordance with some implementations.

FIG. 8 illustrates accounting for user gaze or focus in determining a camera adjustment, in accordance with some implementations.

FIG. 9 is a flowchart illustrating an exemplary method for context-based camera adjustment, in accordance with some implementations.

FIG. 10 is a block diagram of an electronic device of adjusting a camera during passthrough in accordance with some implementations.

FIG. 11 is a block diagram illustrating an exemplary pipeline displaying images of an environment on an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

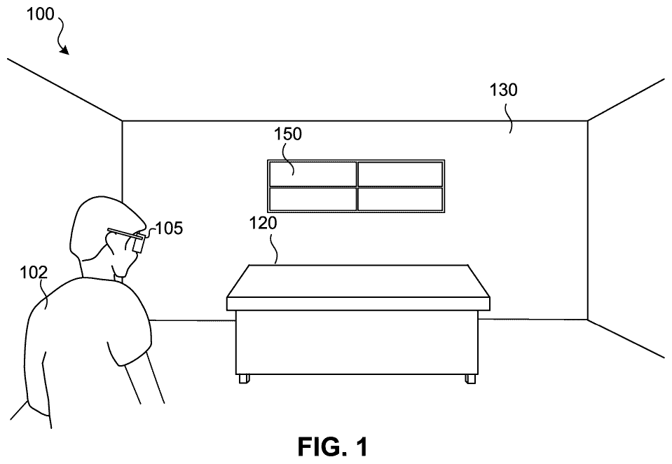

FIG. 1 illustrates an example environment 100 including an exemplary electronic device 105 operating in a physical environment 100. In the example of FIG. 1, the physical environment 100 is a room that includes a desk 120 and a window 150 on wall 130. The electronic device 105 may include one or more cameras, microphones, depth sensors, or other sensors that can be used to capture information about and evaluate the physical environment 100 and the objects within it, as well as information about the user 102 of the electronic device 105. The information about the physical environment 100 and/or user 102 may be used to provide visual and audio content (e.g., associated with the user 102) and/or to identify the current location of the physical environment 100 and/or the location of the user within the physical environment 100. In some implementations, views of an extended reality (XR) environment may be provided to one or more participants (e.g., user 102 and/or other participants not shown) via electronic a device 105, which may be a wearable device such as an HMD, a handheld device such as a mobile device, a tablet computing device, a laptop computer, etc. Such an XR environment may include passthrough video views of a 3D environment (e.g., the proximate physical environment 100) that are generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

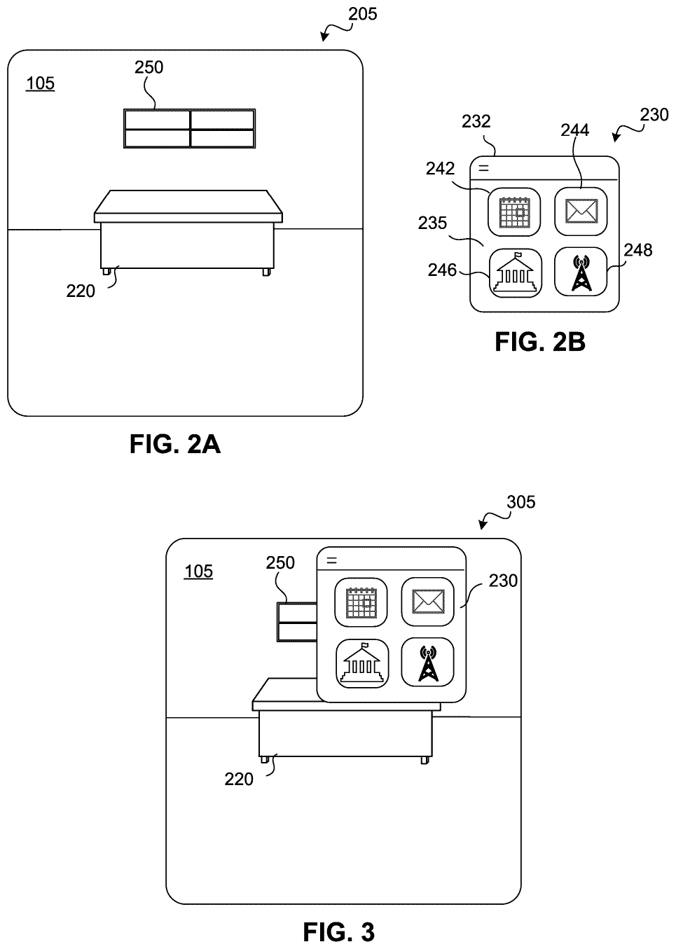

FIG. 2A illustrates an exemplary view 205 of an XR environment in which the view 205 provides only passthrough video of a physical environment 100, including a depiction 220 of desk 120 and a depiction 250 of window 150. In one example, device 105 (FIG. 1) may have one or more outward facing cameras or other image sensors that captures images (e.g., video) of the physical environment 100 that are sequentially displayed on a display of the device 105. The video may be displayed in real-time and thus can be considered passthrough video of the physical environment 100. The video may be modified, e.g., warped or otherwise adjusted, to correspond to a viewpoint of an eye of the physical environment, e.g., so that the user 102 sees the passthrough video of the physical environment from the same viewpoint that user would view the physical environment from if not wearing the device 105 (e.g., seeing physical environments directly with their eye). In some implementations, passthrough video is provided to each of the user's eyes, e.g., with a single outward facing camera capturing images that may be warped/altered to provide a video from the viewpoint of each eye or from multiple outward-facing cameras that provide image data (warped or un-warped) to each eye's viewpoint respectively.

The view 205 may be provided by a device such as device 105 having a display that provides substantially all of the light visible by an eye of the user. For example, the device 105 may be an HMD having a light seal that blocks ambient light of the physical environment 100 from entering an area between the device 105 and the user 102 while the device is being worn such that the device's display provides substantially all of the light visible by the eye of the user. A device's shape may correspond approximately to the shape of the user's face around the user's eyes and thus, when worn, may provide an eye area (e.g., including an eye box) that is substantially sealed from direct/ambient light from the physical environment.

In some implementations, a view of an XR environment includes only depictions of a physical environment such as physical environment 100. A view of an XR environment 100 may be entirely passthrough video. A view of an XR environment may be depict a physical environment based on image, depth, or other sensor data obtained by the device, e.g., generating a 3D representation of the physical environment based on such sensor data and then providing a view of that 3D representation from a particular viewpoint. In some implementations, the XR environment includes entirely virtual content, e.g., an entirely virtual reality (VR) environment that includes no passthrough or other depictions of the physical environment 100. In some implementations, the view of the XR environment includes depictions of both virtual content and depictions of a physical environment 100.

FIG. 2B illustrates an example of virtual content 305 to be added to the view 205 of the XR environment. In this example, the virtual content 230 includes a user interface 232 (e.g., of an app) that includes a background area 235 and icons 242, 244, 246, 248. In this example, the virtual content 230 is approximately planar. In other implementations, virtual content 230 may include non-planar content such as 3D elements.

FIG. 3 illustrates a view 305 of an XR environment including passthrough video of the physical environment 100 and virtual content 230. In this example, the view 305 includes passthrough video including depiction 220 of the desk 120 of the physical environment, as well as virtual content including user interface 232. The virtual content (e.g., user interface 232) may be positioned within the 3D coordinate system as the passthrough video such that the virtual content appears at a consistent position (unless intentionally repositioned) within the XR environment. For example, the user interface 232 may appear at a fixed position relative to the depiction 220 of the desk 120 as the user changes their viewpoint and views the XR environment from different positions and viewing directions. Thus, in some implementations, virtual content is given a fixed position within the 3D environment (e.g., providing world-locked virtual content). In some implementations, virtual content is provided at a fixed position relative to the user (e.g., user-locked virtual content), e.g., so that the user interface 230 will appear to the user remain a fixed distance in front of the user, even as the user moves about and views the environment with virtual content added from different viewpoints.

Providing a view of an XR environment may utilize various techniques for combining the real and virtual content. In one example, 2D images of the physical environment are captured and 2D content of virtual content (e.g., depicting 2D or 3D virtual content) is added (e.g., replacing some of the 2D image content) at appropriate places in the images such that an appearance of a combined 3D environment (e.g., depicting the 3D physical environment with 2D or 3D virtual content at desired 3D positions within it) is provided in the view. The combination of content may be achieved via techniques that facilitate real-time passthrough display of the combined content. In one example, the display values of some of the real image content is adjusted to facilitate efficient combination, e.g., changing the alpha values of real image content pixels for which virtual content will replace the real image content so that a combined image can be quickly and efficiently produced and displayed.

FIG. 11 illustrates an exemplary pipeline displaying images of an environment on an electronic device. In this example, image sensors 1110 utilize ISP 1120 information (e.g., parameters, settings, etc.) to capture image frames 1130 that are modified via passthrough pipeline 1140 and displayed at display 1150 (e.g., a stereo display providing left and right images/views for each eye of a user wearing an HMD). The image sensors 1110 may comprise one or more cameras that capture image of a physical around a user. In an HMD implementation, such sensors may correspond approximately to viewpoint positions for each of the user's eyes.

The capture image frames 1130 may be adjusted in various ways via the image pipeline 1140. Such adjustments may correct the point of view (e.g., performing a point of view correction POVc) so that the images displayed to the user will correspond to the user's point of view in the environment, e.g., providing views of the environment that the user experiences as if they were not wearing an HMD and viewing the environment directly. The adjustments may modify the captured image frames 1130 to account for lens distortion of the image sensor(s) 1110. The adjustments may combine virtual content with the captured image frames 1130 (e.g., to provide an extended reality (XR) experience in which virtual content appears to be positioned at 3D positions within the physical environment). The adjustments may alter the appearance of the captured image frames 1130 and/or blend virtual content (or content from other sensors) with the captured image frames 1130 to provide various effects, e.g., shadows, transparent or translucent virtual content through which the physical environment can be seen, etc.

The functions of the passthrough pipeline 1140 may use be hardware-based, software-based, or use a combination of hardware and software. The functions may be configured to provide flexible adjustments via a camera-to-display pipeline, with sufficiently low latency to enable real-time display. The functions may be performed via dedicated hardware and/or a general-purpose CPU and/or GPU. The adjustments may involve programable compute functions that can be configured during use, e.g. providing application-specific adjustments. The passthrough pipeline may involve a single-system on a chip (SOC) architecture in which adjustments are performed in a power-efficient and/or processing-efficient manner.

Various implementations disclosed herein analyze context to adjust passthrough image capture. For example, camera adjustments (for one or more next frames to be captured) may be performed based on assessing one or more current/recent passthrough camera images, e.g., adjusting camera white balance and/or exposure settings based on the characteristics of one or more recently captured passthrough camera images. Based on contextual analysis of the XR environment and/or the user (e.g., what the user is looking at, focused on, attentive to, etc.), the device may selectively specify which portions of the passthrough camera images are used/analyzed to make such adjustments, e.g., identifying portions of the images that should be ignored or otherwise prioritized in making such camera adjustments. For example, the device may determine that portions of the image correspond to a television and those portions may be excluded from use in determining exposure and/or white balance adjustments. As another example, based on determining that a portion of an image corresponds to a television and that the user is watching the television, the television may be included or given a higher priority in determining exposure and/or white balance adjustments. As another example, based on determining that a user is walking down a hallway and that a window (through which bright sunlight is shining in) has come into view, the portion of the passthrough image corresponding to the window may be excluded from exposure and/or white balance adjustment determinations. However, based on determining that the user is now looking out of the window, those portions of the passthrough images may be included in determining the exposure and white balance adjustment determinations.

In some implementations, data from the one or more cameras used to capture the passthrough video images are used to adjust those one or more cameras to capture later frames during the passthrough video experience. Camera adjustments during the experience may account for the environment, what the user is doing, where the user us gazing/focused, whether the user is moving, sitting, standing, etc., and other contextual factors.

Context may be used to determine which information about a XR experience and/or user to prioritize in making camera adjustment determinations. The cameras and/or other sensors (e.g., of an HMD) may capture data corresponding to a relatively large area of a physical environment (e.g., capturing a FOV of 120 degrees, 130 degrees, or more). Moreover, the device may be moved and be reoriented over time such that the cameras and/or other sensors capture information about even more of the physical environment and some portions of the physical environment may be occluded by virtual content in a user's view. These factors may be accounted for in determining camera adjustments. Camera adjustments may be based on selecting subsets of the sensor-collected information to use in determining the camera adjustments in a way that the adjustments will best account for the environment, what the user is doing, where the user us gazing/focused, whether the user is moving, sitting, standing, etc., and other contextual factors to provide desirable user experiences. In some implementations, portions of the sensor data corresponding to irrelevant or less relevant aspects of the experience may be excluded, masked out, ignored, or otherwise given less priority in such determinations.

Some implementations perform camera adjustments based on information determined based on assessment and/or modeling of a physical environment. Such assessment and/or modeling may involve identifying the 3D positions, types, or other information about objects in the environment and/or performing a 3D reconstruction of the environment, e.g., via a SLAM-based or other type of mapping technique. Such assessment and/or modeling may involve scene classification based on object identification, scene reconstruction, or otherwise.

Some implementations perform camera adjustments based on scene classification, e.g., based on whether the scene is indoor or outdoor, depicts a particular type of room (e.g., a kitchen, office, etc.), etc. For example, based on determining that the scene is indoor, the device may determine that there is no need to account for high lux values (e.g., 40,000 lux) in a reference passthrough image that may be otherwise relevant when outdoors. In some implementations, a device prioritizes luminance ranges (e.g., lighter ranges versus darker ranges) based on the context, e.g., whether elements that in the shadows are the focus of the user's attention or elements that are in the areas that are brightly lit by the sun are the focus of the user's attention. Such information may be provided in the form a histogram. Some implementations account for eye and/or head movement in determining camera adjustments, e.g., using gaze to determine the subject of the user's attention/focus and head speed to control or influence how quickly camera parameter changes will be implemented, e.g., in an instant or more slowly and gradually over a transition period. Motion blur may be predicted based on head motion and accounted for in adjusting exposure. Light flicker (e.g., detected by a flicker detector) may also be used to determined and used to determine camera parameter adjustments.

Some implementations perform camera adjustments by determining which portions of an XR view or corresponding XR environment are relevant and/or likely to become relevant to the user. For example, portions of a physical environment that are occluded or otherwise blocked by virtual content may be treated as less relevant, given a lower priority, or ignored in determining camera parameter adjustments.

### White Balance Examples

White balance adjustments may be determined based on contextual analysis of an XR environment and/or user activity. For example, such adjustments may be based on identifying what activity a user is engaged in, e.g., watching a moving, cooking dinner, watching a social media video, etc. and/or what is the subject of user attention or focus, e.g., whether the user is looking at something near or far, their pupil adaptation state (e.g., dilated or contracted), whether they just woke up, how sensitive their eyes currently are to bright light, etc.

Some implementations facilitate white balance stability by accounting for the environment, user activity, and/or other contextual factors. In one example, a user wearing an HMD device may be proximate and/or using another computer during an HMD passthrough experience. White balance adjustments during such an experience may be undesirable if performed automatically without accounting for context. For example, if the other device's screen has a dominant color that is off-white (e.g., having a yellowing appearance) and this occupies the majority of the HMD view provided to the user and used for white-balance adjustment, the HMD may over-compensate and provide noticeable, unrealistic, and otherwise undesirable changes to the passthrough image capture. Similarly, the physical environment may include mixed lighting, e.g., an office ceiling lighting that is warm color temperature and the computer display providing a colder color temperature. The color rendering (if performed without accounting for context) may result in undesirable white balance adjustments, e.g., such that the color rendering changes when the display enters the HMD user's field of view and the white-point is automatically adjusted to provide a warmer color rendering. Similarly, during the experience the user may look at their hands (e.g., shifting their attention/focus from looking at the other device's display to looking at their hands) and the white-point selected based on the office lighting and/or other display may provide an appearance of the skin that is unrealistic and otherwise objectionable, e.g., differing from the user's expectation.

Some implementations perform white balance adjustments based on a contextual understanding that accounts for spectral distribution in an environment and/or an understanding of / mapping of the surfaces in that environment. A surface identification algorithm that uses the image pixel values and/or other sensor information may be used to identify surfaces, surface types, provide lighting estimates, and/or other information used to determine white balance adjustments. Semantic information may additionally or alternatively be determined and used to determine white balance adjustments, e.g., identifying that a portion of an image corresponds to a face, another portion corresponds to a table, etc. A user information identification algorithm that uses sensor-based or user-supplied information about the user may be used to identify user information, e.g., regarding what the user is doing, what the user is looking at, focused on, attentive to, etc., what the user is about to do next and for how long, etc.

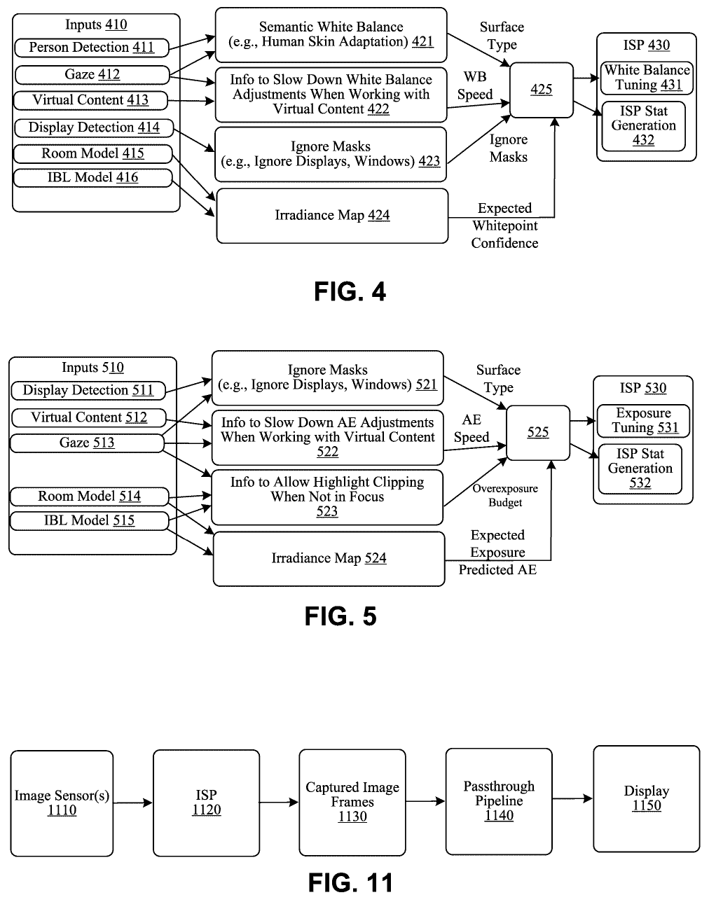

FIG. 4 illustrates a chart of exemplary ways in which various inputs may be used to facilitate white balance adjustments. In these examples, a device such as an HMD uses various inputs to determine information that is used to directly or indirectly (e.g., via a process 425) influence or otherwise enact white balance adjustments during a passthrough experience. The inputs 410 in these examples may include person detection 411 (e.g., detecting portions of image data corresponding to one or more other persons (other than the user), that the person is involved in the experience (e.g., the subject of breakthrough/interruption during the experience), etc. The inputs 410 in these examples may include gaze detection 412 (e.g., detecting where a user is looking, what they are looking at, how long they have been looking at it, predicting how long they will continue to look at it, etc.). The inputs 410 in these examples may include virtual content identification 413 (e.g., identifying where virtual content is in an XR environment or view of an XR environment, what the virtual content includes, how the user is interacting with the virtual content, what the virtual content is occluding, etc.). The inputs 410 in these examples may include display detection 414 (e.g., detecting the presence and/or locations of televisions and other electronic displays) and/or other light source detection (e.g., detecting the presence and/or locations of windows, doors, etc. that correspond to different lighting environments or light sources). The inputs 410 in these examples may include room modeling 415 (e.g., identifying the shape, size, and/or other characteristics of the environment). The inputs 410 in these examples may include image-based lighting (IBL) modeling 416 or other environment light modeling. Other contextual information may additionally or alternatively be used as inputs for white balance adjustment determinations.

Contextual information may be used in various ways with respect to white-balance adjustments. Contextual information may be used, as example, to determine what type of content to prioritize (e.g., based on semantic labels associated with different content), control the rate of change to enhance or optimize user comfort (e.g., controlling how quickly white balance will be adjusted over time), manipulating/excluding the raw sensor inputs to target particular content (e.g., of a particular type) and/or to remove information that may result in an undesirable change (e.g., using an ignore mask to remove from consideration information about content the user will not see and/or is not attentive to), and/or self-regulating the context-based adjustment process (e.g., avoiding making changes when sensor data is unreliable, incomplete, or otherwise not representative of information appropriate to base changes upon.

In FIG. 4, the process 425 and/or ISP may use various pieces of contextual information to perform white balance tuning 431 and/or ISP statistic generation 432. Information may be provided to an ISP pipeline in a way that the ISP pipeline does not need to be changed to account for the additional information, e.g., providing masked out information in images provided to an ISP so that it will (as a result of the mask) ignore or otherwise exclude from consideration information that it otherwise would consider in making a white balance adjustment determination. An ISP may be configured to process images, histograms, and other forms of information that is provided or altered to facilitate or implement white balance adjustment determinations.

The example of FIG. 4 illustrates a first type of information (i.e., semantic white balance information 421) used to facilitate a white balance adjustment. In this example, semantic white balance information 421 is based on the person detection 411 and gaze 412 inputs and provides information relevant to making a desirable white balance adjustment (e.g., adapting white balance to account for or prioritize the appearance of human skin). The semantic white balance information 421 may provide information about surface types (e.g., human skin, etc.) to process 425 to prioritize in the white balance adjustments.

The example of FIG. 4 illustrates a second type of information (i.e., info to slowdown white balance adjustments when the user is working with virtual content 422) used to facilitate a white balance adjustment. In this example, the info to slow down white balance adjustment when the user is working with virtual content 422 is based on gaze 412 and virtual content 413 inputs and provides information relevant to making a desirable white balance adjustment (e.g., performing slower white balance transitions over time when the user is working with virtual content). The info to slow down white balance adjustments when the user is working with virtual content 422 may provide information about an appropriate white balance transition speed or time frame.

The example of FIG. 4 illustrates a third type of information (i.e., ignore masks 423) used to facilitate a white balance adjustment. In this example, ignore masks 423 information is based the display detection 414 input and provides information relevant to making a desirable white balance adjustment (e.g., identifying portions of passthrough images that should be ignored in determining white balance adjustments).

The example of FIG. 4 illustrates a fourth type of information (i.e., an irradiance map 424) used to facilitate a white balance adjustment. In this example, irradiance map 424 information is based the room model 415 and IBL map 416 inputs and provides information relevant to making a desirable white balance adjustment (e.g., identifying expected white-point confidence). This may involve using information from additional frames, e.g., to optimize in a way that accounts for the possibility that the user will move or change the FOV. The information may be used to anticipate a color temperature that is (or will be) appropriate. For example, a prediction of pose and the nature/color temperatures of the lights in the environment may be used to identify an appropriate temperature, e.g., identifying an appropriate color temperature when there is natural daylight but the user starts turning towards a tungsten light.

### Exposure Examples

Exposure adjustments may be determined based on contextual analysis of an XR environment and/or user activity. For example, such adjustments may be based on identifying what activity a user is engaged in, e.g., watching a moving, cooking dinner, watching a social media video, etc. and/or what is the subject of user attention or focus, e.g., whether the user is looking at something near or far, their pupil adaptation state (e.g., dilated or contracted), whether they just woke up, how sensitive their eyes currently are to bright light, etc.

Some implementations facilitate exposure adjustments by accounting for the environment, user activity, and/or other contextual factors. In one example, in the absence of accounting for context, a user wearing an HMD device may experience undesirable auto exposure adjustments in a mixed lighting environment when they pan from darker to brighter portions of a scene and vice versa, e.g., the user may experience the whole view appearing to get noticeable brighter or dimmer for no apparent reason based on an automatic adjustment. As another example, in the absence of accounting for context, an HMD user's view while walking down a hallway that has windows to a brighter outdoor environment while the user is focused on indoor content may experience a view that (being based at least in part on the bright outdoor portion of captured image data) is adjusted to be undesirably dim.

Contextual information may be used in various ways with respect to exposure adjustments. Contextual information may be used, as example, to determine what type of content to prioritize (e.g., based on semantic labels associated with different content), control the rate of change to enhance or optimize user comfort (e.g., controlling how quickly auto exposure will be when a user is involved in a particular type of activity, e.g., working with virtual content), manipulating/excluding the raw sensor inputs to target particular content (e.g., of a particular type) and/or to remove information that may result in an undesirable change (e.g., allow exposure adjustments that detrimentally affect portions of the content that the user is not attentive to (e.g., allowing highlight clipping of content the user is not focused upon)), and/or self-regulating the context-based adjustment process (e.g., avoiding making changes when sensor data is unreliable, incomplete, or otherwise not representative of information appropriate to base changes upon.

FIG. 5 illustrates a chart of exemplary ways in which various inputs may be used to facilitate exposure adjustments. In these examples, a device such as an HMD uses various inputs to determine information that is used to directly or indirectly (e.g., via a process 525) influence or otherwise enact exposure adjustments during a passthrough experience. The inputs 510 in these examples may include display detection 511 (e.g., detecting the presence and/or locations of televisions and other electronic displays) and/or other light source detection (e.g., detecting the presence and/or locations of windows, doors, etc. that correspond to different lighting environments or light sources). The inputs 510 in these examples may include virtual content identification 512 (e.g., identifying where virtual content is in an XR environment or view of an XR environment, what the virtual content includes, how the user is interacting with the virtual content, what the virtual content is occluding, etc.). The inputs 410 in these examples may include gaze detection 513 (e.g., detecting where a user is looking, what they are looking at, how long they have been looking at it, predicting how long they will continue to look at it, etc.). The inputs 410 in these examples may include room modeling 514 (e.g., identifying the shape, size, and/or other characteristics of the environment). The inputs 510 in these examples may include image-based lighting (IBL) 515 modeling or other environment light modeling. Other contextual information may additionally or alternatively be used as inputs for white balance adjustment determinations.

The process 525 and/or ISP may use various pieces of contextual information to perform exposure tuning 531 and/or ISP statistic generation 532. Information may be provided to an ISP pipeline in a way that the ISP pipeline does not need to be changed to account for the additional information, e.g., providing masked out information in images provided to an ISP so that it will (as a result of the mask) ignore or otherwise exclude from consideration information that it otherwise would consider in making an exposure adjustment determination. An ISP may be configured to process images, histograms, and other forms of information that is provided or altered to facilitate or implement exposure adjustment determinations.

The example of FIG. 5 illustrates a first type of information (i.e., ignore masks 521) used to facilitate a white balance adjustment. In this example, ignore masks 521 information is based the display detection 511 input and provides information relevant to making a desirable exposure adjustment (e.g., identifying portions of passthrough images that should be ignored in determining exposure adjustments).

The example of FIG. 5 illustrates a second type of information (i.e., info to slowdown exposure adjustments when the user is working with virtual content 522) used to facilitate an exposure adjustment. In this example, the info to slow down exposure adjustment when the user is working with virtual content 522 is based the gaze 513 and virtual content 512 inputs and provides information relevant to making a desirable exposure adjustment (e.g., performing slower exposure transitions over time when the user is working with virtual content). The info to slow down exposure adjustments when the user is working with virtual content 522 may provide information about an appropriate auto exposure transition speed and/or time frame.

The example of FIG. 5 illustrates a third type of information (i.e., info to allow highlight clipping when not in focus 523) used to facilitate an exposure adjustment. In this example, the info to allow highlight clipping when not in focus 523 is based the gaze 513, the room model 514, and the IBL model 515 inputs and provides information relevant to making a desirable exposure adjustment (e.g., providing an overexposure budget. For example, when someone walks into a room where there are both shadows and a window showing a very bright outdoor, lowering the exposure to adjust to the outside may make the inside look noisy and possibly make it difficult for the user to adequately see dark objects (e.g., to better ensure that the user does not trip on the foot of a black desk chair). In one example, determining that that the user is not looking through the window is used to determine to increase exposure for the inside of the room, so the room is less noisy and less prone to crushed shadows.

Highlight clipping may occur when parts of the scene are too bright for a particular exposure length, and the integrated pixel values reach their limit, i.e., they're overexposed, e.g., where there is a sunny window visible in an indoor scene. The pixels for the window may all cap out to pure white. The camera/ISP may by default try to avoid such overexposure, but this may be over-riden by allowing more overexposure (e.g., increasing an over-exposure budget) when, based on context (e.g., gaze, VR content), the system determines that it is acceptable to do so, e.g., when the user is not looking at the window where the sun is visible. In such scenarios, it may not matter to the user that the window looks washed out.

The example of FIG. 5 illustrates a fourth type of information (i.e., an irradiance map 524) used to facilitate an exposure adjustment. In this example, irradiance map 524 information is based the room model 514 and IBL map 515 inputs and provides information relevant to making a desirable exposure adjustment (e.g., identifying an expected exposure, predicted auto exposure, etc.). This may involve using information from additional frames, e.g., to optimize in a way that accounts for the possibility that the user will move or change the FOV.

Knowing light locations and light characteristics may enable optimization of the dynamic range for a scene and/or increase the perceptual stability. For example, if there is a desk lamp over a book and the user works on the desk outside the light beam and sometimes looks at the book, it may be undesirable to make an adjustment every time the user looks at the book, so the system may use an exposure and tone mapping combination that will work for both the desk and the bright area around the book. Based on determining that the user gaze is on the book the system determines that the book needs to be accounted for (e.g., not clipped) when the user starts moving his head towards the book. The system may determine an optimal strategy, e.g., keep a stable exposure for both the desk and the book and/or, if adjusting dynamically, use the prediction of pose and the lights that will be in the field of view to avoid clipping and/or adjusting too late.

### Mask Examples

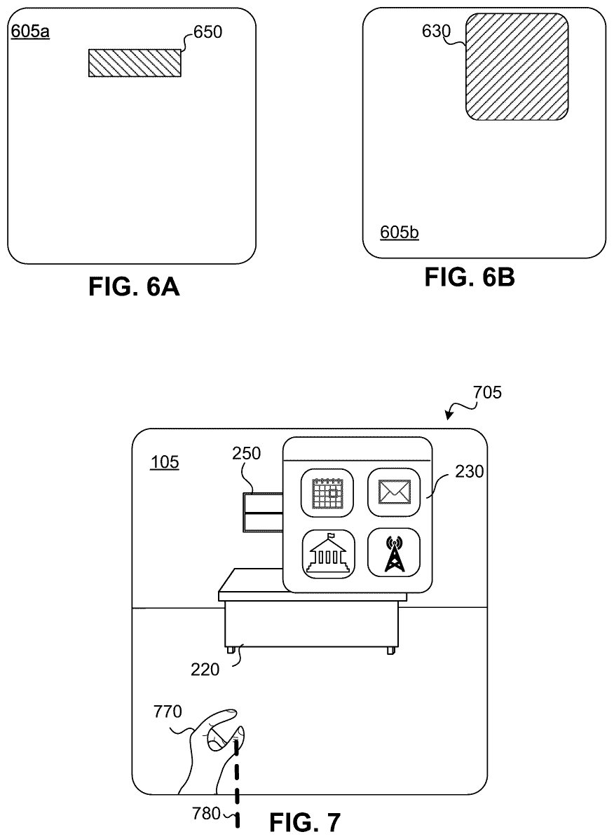

FIGS. 6A-6B illustrate exemplary masks identifying portion of passthrough images to exclude in determining camera adjustments. In FIG. 6A, the masked area 650 of mask 605a corresponds to a portion of an image corresponding to view 205 (a portion corresponding to depiction 250 of window 150 of FIG. 2A) that will be ignored or given less priority in making a camera parameter adjustment. Such a masked area 650 may be identified based on an analysis (e.g., a semantic analysis) that identifies portions of the image corresponding to the view 205 that has a particular classification (e.g., window, open door, glass door, exterior exit, etc.). In FIG. 6B, the masked area 630 of mask 605b corresponds to a portion of an image corresponding to view 205 (a portion corresponding to a portion that will be occluded by virtual content 230 in the view 305) that will be ignored or given less priority in making a camera parameter adjustment. Such a masked area 630 may be identified based on an analysis that identifies the position of virtual content. Masks may define how various portions of a depicted scene will be considered, e.g., which portions will not be considered, which portions are to be emphasized/prioritized, etc. Masks can utilize various shapes and sizes. Masks need not be binary (e.g., consider or don't consider). Rather masks may provide weighting and/or scaling factors that define how different portions of depicted environment should be considered, e.g., weighting portions that the user is attentive to as twice as important as portions that the user is not as attentive to in considering how to adjust camera parameters.

### Gaze/Focus Examples

FIG. 7 illustrates accounting for user gaze or focus in determining a camera adjustment. In FIG. 7, the device 105 determines that the user is looking at depiction 770 of a hand of the user in view 705 and uses this information in making a camera parameter adjustment (e.g., to ensure desirable skin appearance). Such info may be identified based on an analysis (e.g., a semantic analysis identifying the hand and other object types depicted and/or an analysis of gaze direction 780) that identifies a type of object that is the subject of the user's gaze, focus, attention, etc.

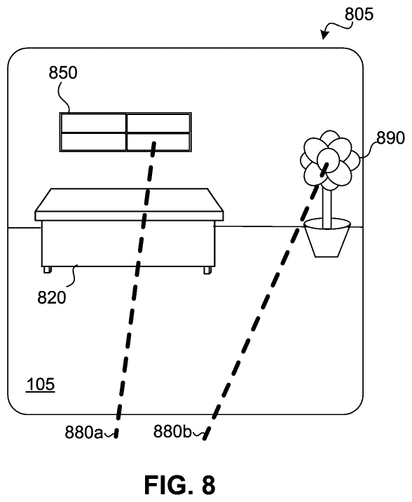

FIG. 8 illustrates accounting for user gaze or focus in determining a camera adjustment. In this example, the device 105 determines that the users gaze has transitioned from looking at a bright exterior environment through a window (e.g., looking through depiction 850 of window 150) to looking at a dimmer interior environment (e.g., looking at depiction 890 of a potted plant) and uses this information in making a camera parameter adjustment (e.g., to reprioritize darker and lighter content different over time). Such info may be identified based on an analysis (e.g., a semantic analysis identifying portions of a view corresponding to indoor versus outdoor areas and/or an analysis of gaze direction 880a-b) that identifies portions of scene/image that are relevant, identifying a priority (e.g., bright versus dark, indoor versus outdoor, etc.).

### Exemplary Process

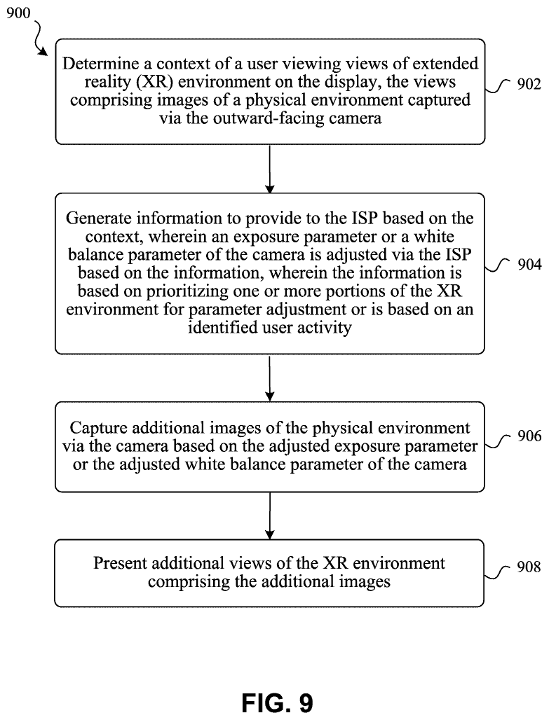

FIG. 9 is a flowchart illustrating an exemplary method 900 for context-based camera adjustment, in accordance with some implementations. In some implementations, the method 800 is performed by a device, such as an HMD (e.g., device 105 of FIG. 1), desktop, laptop, mobile device, or server device. In some implementations, the device has a screen for displaying images and/or a screen for viewing stereoscopic images such as an HMD e.g., device 105. In some implementations, the method 900 is performed by processing logic, including hardware, firmware, software, or a combination thereof. In some implementations, the method 900 is performed by a processor executing code stored in a non-transitory computer-readable medium (e.g., a memory). Each of the blocks in the method 900 may be enabled and executed in any order.

At block 902, the method 900 involves determining a context of a user viewing views of an XR environment on the display, the views comprising images of a physical environment captured via the outward-facing camera. The views may include (or be based upon) a passthrough video signal from an image sensor such as a camera. In some implementations, the passthrough video signal includes passthrough video depicting a physical environment. In some implementations, the passthrough video may be associated with image signal processor (ISP)-implemented camera parameters, e.g., white balance, auto exposure, tone map (e.g., curve), etc.

At block 904, the method 900 involves generating information to provide to the ISP based on the context, wherein an exposure parameter or a white balance parameter of the camera is adjusted via the ISP based on the information. The information may be based on prioritizing one or more portions of the XR environment for parameter adjustment, e.g., masking out other displays, windows, etc., identifying a focus on the user's hands based on gaze, identifying an interaction with another person based on gaze and/or change in the XR environment, identifying virtual content occluding other elements, etc. The information may comprise an image mask identifying regions of the images to be ignored in adjusting the exposure parameter or the white balance parameter. The information may be based on an identified user activity (e.g., where user is looking head speed, etc.

In some implementations, a white balance parameter is adjusted using the information and the information comprises: a mask identifying portions of the images corresponding to one or more external displays and/or a mask identifying portions of the images corresponding to one or more windows. In some implementations, a white balance parameter is adjusted using the information and the information is based on identifying that user attention is directed to another person and/or identifying that user attention is directed to one or more hands of the user. In some implementations, a white balance parameter is adjusted using the information and the information is based on a first determination of user gaze direction and a second determination of a user head movement characteristic (e.g., speed).

In some implementations, the exposure parameter comprises an auto exposure parameter. In some implementations, an exposure parameter is adjusted using the information and the information comprises a mask identifying portions of the images corresponding to elements outside of a user attention or user interest. In some implementations, an exposure parameter is adjusted using the information and the information comprises both an eye characteristic (e.g., where the user is looking) and a head speed.

In some implementations, an exposure parameter and/or white balance parameter is adjusted using the information and the information identifies portions of the images occluded by virtual content being presenting in the XR environment.

At block 906, the method 900 involves capturing additional images of the physical environment via the camera based on the adjusted exposure parameter or the adjusted white balance parameter of the camera. The information may be used to directly adjusts the exposure parameter or the white balance parameter, e.g., rather than providing a mask to the ISP, providing white balance and/or exposure parameters directly to the ISP.

At block 908, the method 900 involves presenting additional views of the XR environment comprising the additional images.

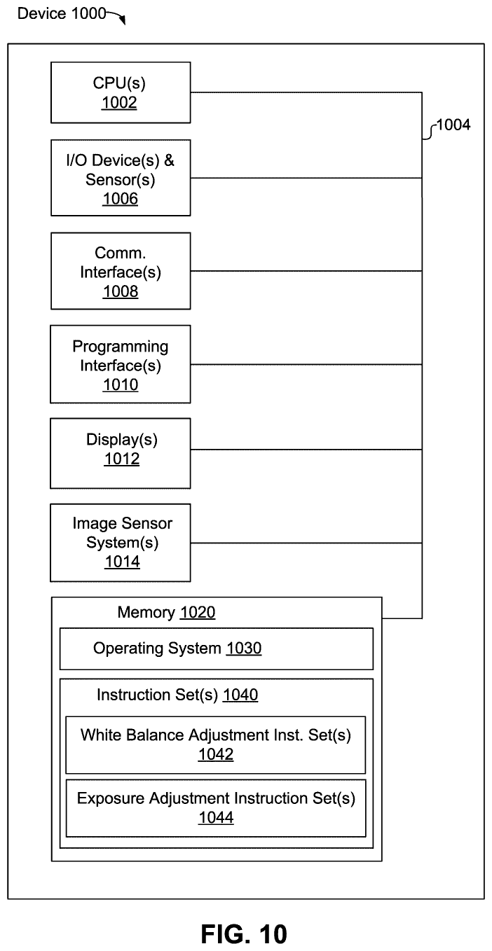

FIG. 10 is a block diagram of an example device 1000. Device 1000 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1004, one or more communication interfaces 1008 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 1010, output devices (e.g., one or more displays) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 1012 are configured to present a view of a physical environment, a graphical environment, an extended reality environment, etc. to the user. In some implementations, the one or more displays 1012 are configured to present content (determined based on a determined user/object location of the user within the physical environment) to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 1012 correspond to diffractive, reflective, polarized, holographic, etc. waveguide displays. In one example, the device 1000 includes a single display. In another example, the device 1000 includes a display for each eye of the user.

In some implementations, the one or more image sensor systems 1014 are configured to obtain image data that corresponds to at least a portion of the physical environment 100. For example, the one or more image sensor systems 1014 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 1000 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 1000 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 1000.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 includes a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include a white balance adjustment instruction set 1042 and an exposure instruction set 1044 performing white balance and exposure adjustment functions as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, FIG. 10 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

As described above, one aspect of the present technology is the gathering and use of information (which may include physiological data and/or environmental data) to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head-mounted device (HMD) having a processor, a display, and an outward-facing camera configured for tuning via an image signal processor (ISP):
determining a context of a user viewing views of an extended reality (XR) environment on the display, the views comprising images of a physical environment captured via the outward-facing camera;
generating information to provide to the ISP based on the context, wherein an exposure parameter or a white balance parameter of the camera is adjusted via the ISP based on the information, wherein the information is based on prioritizes one or more portions of the XR environment for parameter adjustment or is based on an identified user activity;
capturing additional images of the physical environment via the camera based on the adjusted exposure parameter or the adjusted white balance parameter of the camera; and
presenting additional views of the XR environment comprising the additional images.

2. The method of claim 1, wherein the information comprises an image mask identifying regions of the images to be ignored in adjusting the exposure parameter or the white balance parameter.

3. The method of claim 1, wherein the information directly adjusts the exposure parameter or the white balance parameter.

4. The method of claim 1, wherein the white balance parameter is adjusted using the information, the information comprising a mask identifying portions of the images corresponding to one or more external displays.

5. The method of claim 1, wherein the white balance parameter is adjusted using the information, the information comprising a mask identifying portions of the images corresponding to one or more windows.

6. The method of claim 1, wherein the white balance parameter is adjusted using the information, the information based on identifying that user attention is directed to another person.

7. The method of claim 1, wherein the white balance parameter is adjusted using the information, the information based on identifying that user attention is directed to one or more hands of the user.

8. The method of claim 1, wherein the white balance parameter is adjusted using the information, the information based on a first determination of user gaze direction and a second determination of a user head movement characteristic.

9. The method of claim 1, wherein the exposure parameter comprises an auto exposure parameter.

10. The method of claim 1, wherein the exposure parameter is adjusted using the information, the information comprising a mask identifying portions of the images corresponding to elements outside of a user attention or user interest.

11. The method of claim 1, wherein the exposure parameter is adjusted using the information, the information comprising both an eye characteristic (e.g., where the user is looking) and a head speed.

12. The method of claim 1, wherein the exposure parameter is adjusted using the information, the information identifying portions of the images occluded by virtual content being presenting in the XR environment.

13. A head-mounted-device (HMD) comprising:
a non-transitory computer-readable storage medium;
a display; and
one or more processors coupled to the non-transitory computer-readable storage medium, wherein the non-transitory computer-readable storage medium comprises program instructions that, when executed on the one or more processors, cause performance of operations comprising:
determining a context of a user viewing views of an extended reality (XR) environment on the display, the views comprising images of a physical environment captured via the outward-facing camera;
generating information to provide to the ISP based on the context, wherein an exposure parameter or a white balance parameter of the camera is adjusted via the ISP based on the information, wherein the information is based on prioritizes one or more portions of the XR environment for parameter adjustment or is based on an identified user activity;
capturing additional images of the physical environment via the camera based on the adjusted exposure parameter or the adjusted white balance parameter of the camera; and
presenting additional views of the XR environment comprising the additional images.

14. The HMD of claim 13, wherein the information comprises an image mask identifying regions of the images to be ignored in adjusting the exposure parameter or the white balance parameter.

15. The HMD of claim 13, wherein the information directly adjusts the exposure parameter or the white balance parameter.

16. The HMD of claim 13, wherein the white balance parameter is adjusted using the information, the information comprising a mask identifying portions of the images corresponding to one or more external displays.

17. The HMD of claim 13, wherein the white balance parameter is adjusted using the information, the information comprising a mask identifying portions of the images corresponding to one or more windows.

18. The HMD of claim 13, wherein the white balance parameter is adjusted using the information, the information based on identifying that user attention is directed to another person.

19. The HMD of claim 13, wherein the white balance parameter is adjusted using the information, the information based on identifying that user attention is directed to one or more hands of the user.

20. A non-transitory computer-readable storage medium storing program instructions executable via one or more processors, of a head-mounted-device having a display, to perform operations comprising:
determining a context of a user viewing views of an extended reality (XR) environment on the display, the views comprising images of a physical environment captured via the outward-facing camera;
generating information to provide to the ISP based on the context, wherein an exposure parameter or a white balance parameter of the camera is adjusted via the ISP based on the information, wherein the information is based on prioritizes one or more portions of the XR environment for parameter adjustment or is based on an identified user activity;
capturing additional images of the physical environment via the camera based on the adjusted exposure parameter or the adjusted white balance parameter of the camera; and
presenting additional views of the XR environment comprising the additional images.
